(19) United States
(12) Patent Application Publication
(10) Pub. No.: US 2008/0065990 A1
(43) Pub. Date: Mar. 13, 2008

(54) Integrated product branding method

(76) Inventors: Fredrick W. Harrison, Winston Salem, NC (US); Brian Sloyer, Oldsmar, FL (US)

Correspondence Address: SARA A. CENTIONI;NEXSEN PRUET JACOBS & POLLARD, LLC, PO DRAWER 10107, GREENVILLE, SC, 29603, US

(21) Appl. No.: 11/529,006

(22) Filed: Sep. 28, 2006

Related U.S. Application Data
(63) Continuation-in-part of application No. 11/387,112, filed on Mar. 22, 2006.

(51) Int. Cl. H04N 5/445

(52) U.S. Cl. 715/719; 725/37

(57) ABSTRACT

An improved method for advertising which provides synergism between published media and broadcast media. The method includes forming a video wherein the video has items of commerce in at least one frame. Capturing the frame. Annotating the captured frame with at least one product attribute of the item thereby forming a publication image. Publishing the publication image and broadcasting the video.

### CROSS-REFERENCE TO RELATED APPLICATIONS

The present application is a Continuation-In-Part of U.S. Nonprovisional application Ser. No. 11/287,112 filed Mar. 22, 2006, which is pending and incorporated herein by reference, which, in turn, claims priority to U.S. Provisional Application No. 60/664,810 filed Mar. 24, 2005, which is expired and further incorporated herein by reference.

### BACKGROUND OF THE INVENTION

The present invention is directed to an integrated product branding method wherein branded products utilized in video scenes can be tagged to enable their sale on the internet prior to, during and after the broadcast.

The ongoing availability and utilization of technology in the entertainment arena has minimized the effectiveness of spot commercials played during a broadcast. In past decades television shows were interspersed with commercials for a large variety of items of commerce. The consumer had very few options for avoiding the commercial with the limited exceptions being physically leaving the vicinity or turning off the video and/or audio. This was typically not done so advertisers could almost guarantee that the advertisement was receiving virtually the same percentage of the viewing audience as the underlying broadcast.

Recorders, such as video cassette recorders (VCR), slightly decreased the number of viewers for the commercials since viewers could record the broadcast for later replay with the option to fast-forward through the commercials. The effort involved in recording and replaying the show did not drastically reduce the ratio of commercial viewers relative to broadcast viewers.

Consumers now have access to many more modes of entertainment and many more broadcast options. Instead of a few channels the consumer can now select between hundreds of channels thereby increasing the competition for any given broadcast and further eroding the percentage of the viewing population being reached by any given commercial. This problem has been exasperated by the introduction of digital recording equipment, such as TiVo and digital video recorders, wherein the ease of operation relative to analog recorders has greatly increased the overall use. It is estimated that by the year 2008 TiVo and digital video recorders will have achieved a 20% market penetration and that by 2010 this will increase to 40%. The net result is a continued erosion in the effectiveness of commercials that are interspersed with broadcast. This trend is expected to continue without abatement.

In an effort to combat the erosion advertisers have begun placing products in prominent locations as part of the broadcast show. It is now riot uncommon to see actors in a broadcast mention products as part of the dialogue or to insure that the label of a product is readily visible to the viewing audience. This technique of embedding products, referred to as branding or integration, provides the advertiser with some level of certainty that the viewing audience for the embedded advertisement is the same as that of the underlying broadcast. The effectiveness of this method is limited. First, the creativeness of the broadcast is hindered by the contractual requirement of showcasing a product. It is often difficult to include a statement, or demonstration, of the desirability of a product within the context of the broadcast without losing the underlying theme and continuity of the conversation or action. Furthermore, the viewer has a limited opportunity to make a purchasing decision since it is virtually impossible to get the full benefit of a commercial including how or where to purchase the product and other assorted information such as the manufacturer, related products, options, contraindications and the like.

More recently efforts have been undertaken to utilize “interactive technology” wherein a viewer can access information about items within the scene of a broadcast by either accessing previously stored information or by accessing the internet through a parallel or integrated server. If, for example, a viewer sees a particular clothing item on a favorite actor or actress the viewer has the option to inquire further into the item and possibly execute a purchase or be led to images wherein the purchase can be made through the internet. This technology has a disadvantage in that the viewer has no prior expectation of the product appearing. If a viewer is interested in a particular item, or prop, by the time they realize their interest the product may be no longer in view and the viewer fails to capture the pertinent purchasing information. In essence, the advertiser has lost the impulse buying opportunity and these are seldom recovered.

In spite of the advancements in the art there are still ongoing desires to increase brand awareness and product desire through effective advertising. In particular, the art has been lacking a method for enticing viewers to seek opportunities to view and purchase products either through interactive techniques or directly.

### SUMMARY OF THE INVENTION

It is an object of the present invention to provide a method for increasing brand awareness by integrating advertisements from print media and the internet with broadcast views demonstrating and illustrating the branded product.

It is another object of the present invention to entice broadcast viewers by correlating broadcast with branded products.

A particular feature of the present invention is the ability to isolate and tag branded products within a video clip that is subsequently published on the internet, thereby creating synergism between e-commerce and broadcast and increasing the advertising opportunities of each.

These and other objects, as will be realized, are provided in a method for advertising. The method includes providing a video wherein the video has items of commerce in at least one frame. Capturing the frame. Annotating the captured frame by isolating and tagging at least one item of commerce to enable its sale on the internet. Creating a publication image including the tagged item and connecting the publication image to a server. Publishing the publication image and broadcasting the video.

Yet another embodiment is provided in a system for advertising. The system has a video wherein the video comprises at least one frame with at least one item displayed therein. A publication image is provided with the frame and a display window with at least one product attribute of the item.

Yet another embodiment is provided in a method for advertising. The method includes forming a frame wherein the frame has at least one item of commerce illustrated therein. The frame is annotated with at least one product attribute of the item thereby forming a publication image. The publication image is published and the video is broadcast.

Yet another embodiment is provided in a system for advertising. The system has a frame with at least one item displayed therein and a publication image with the frame and a display window with at least one product attribute of the item.

### BRIEF DESCRIPTION OF FIGURES

FIG. 1 illustrates components of the present invention

FIG. 2 illustrates an optional, and preferred component of the present invention.

FIG. 3 is a flow chart illustration of the method of an embodiment of the present invention.

FIG. 4 is a flow chart illustration of the method of an embodiment of the present invention.

FIG. 4A is a screen shot of an example of an embodiment of the present invention.

FIG. 5 is a flow chart illustration of the method of an embodiment of the present invention.

FIG. 5A is a screen shot of an example of an embodiment of the present invention.

FIG. 5B is a screen shot of an example of an embodiment of the present invention.

FIG. 6 is a flow chart illustration of the method of an embodiment of the present invention.

FIG. 6A is a screen shot of an example of an embodiment of the present invention.

FIG. 6B is a screen shot of an example of an embodiment of the present invention.

FIG. 6C is a screen shot of an example of an embodiment of the present invention.

FIG. 7 is a flow chart illustration of the method of an embodiment of the present invention.

FIG. 7A is a screen shot of an example of an embodiment of the present invention.

FIG. 7B is a screen shot of an example of an embodiment of the present invention.

FIG. 7C is a screen shot of an example of an embodiment of the present invention.

FIG. 8 is a flow chart illustration of the method of an embodiment of the present invention.

FIG. 8A is a screen shot of an example of an embodiment of the present invention.

FIG. 8B is a screen shot of an example of an embodiment of the present invention.

FIG. 9 is a flow chart illustration of the method of an embodiment of the present invention.

FIG. 10 is a reproduction of a print media based representation of an embodiment of the present invention

FIG. 11 is a reproduction of an internet based representation of an embodiment of the present invention.

### DETAILED DESCRIPTION OF THE INVENTION

The present invention will be described with reference to the various figures forming an integral part of the instant specification.

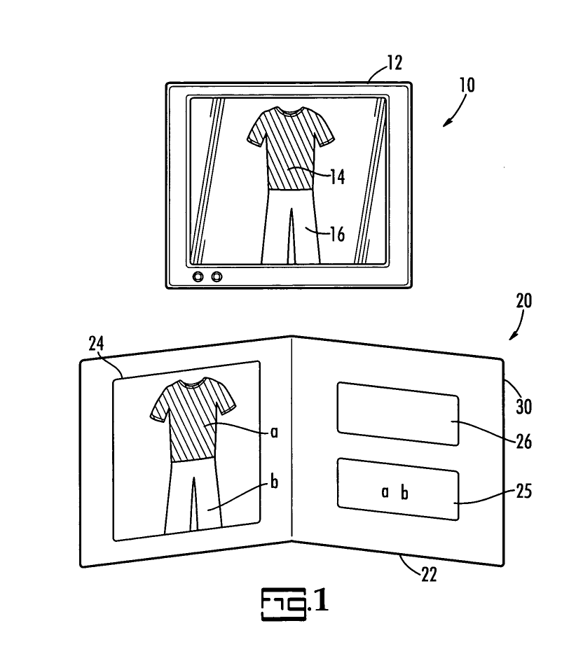

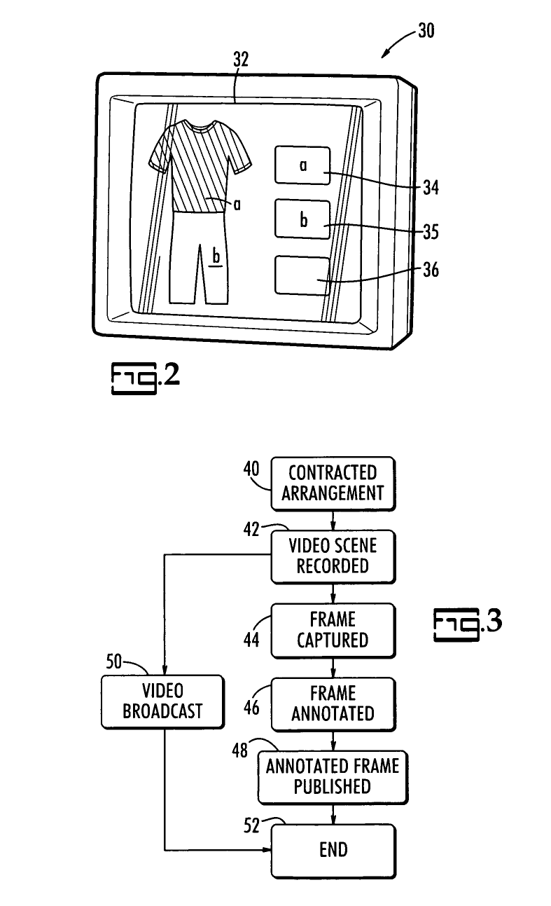

The preferred components of the present invention are illustrated in FIG. 1. In FIG. 1, a frame of a scene of a video broadcast is indicated at 10 appearing on a screen, 12. The frame comprises a multiplicity of items. The first item, 14, indicated herein as a shirt, and second item, 16, indicated as pants, are items that may be of interest to a viewer. While indicated as clothing the item may be any item, consumable, wearable, durable or otherwise which could be of interest to a viewer. A separately distributed media, 20, in the form of print media, 22, comprises the frame, 24, with annotation such that product attributes of the item of interest can be obtained. In the example of FIG. 1, the shirt is annotated with an “a” and the pants are annotated with a “b.” In a further embodiment, detail windows, 25 and 26, provide additional information such as product attributes. One detail window, 25, for example, may include product attributes which are details and further characterization of the product such as the purchase information, color, size, available options, availability, website contact, company contact, contraindications, disclaimers, logos, slogans or any other information typically included in an audio, video or print advertisement. A second detail window, 26 for example, may include information which correlates the particular item to the broadcast. For example, the show, date, time, channel or network may be included such that a person viewing the item with interest will be alerted to an opportunity to see the actual item in a broadcast.

A particular advantage of the correlated print media and broadcast is the opportunity to entice the viewer of the print media to view the broadcast. Conversely, a broadcast viewer realizing that more details of the items are available will be enticed to purchase, or subscribe to, the print media. The advertiser therefore multiplies the opportunities for interest due to the synergism created by the print media and broadcast.

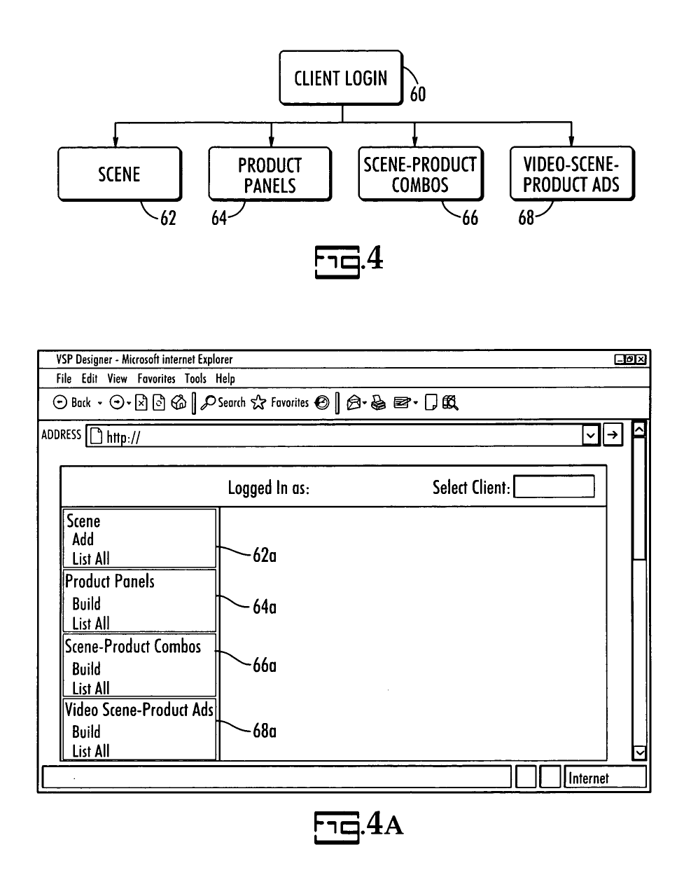

FIG. 2 illustrates a preferred embodiment of the present invention. In FIG. 2, the media is a computer terminal, 30, with a website image, 32, thereon. The website presents the frame with annotation in a manner directly analogous to the print media. Icons, 34-36, which may be interactive, provide additional information related to the item of commerce. The icon may include all pertinent information such as purchase information, color, size, available options, availability, company contact, contraindications, disclaimers, logos, slogans or any other information typically included in an audio, video or print advertisement. The icon may also direct the user to a purchase opportunity as commonly done in internet based commerce. In the present non-limiting example icon 34 is specific to the details of item “a” whereas icon 35 is specific to the details of item “b”. Icon 36 may be a navigational icon which, when engaged by the user, returns the user to a previous webpage, advances to additional products, advances to a purchase closure screen, or any other navigational tool useful for internet communication.

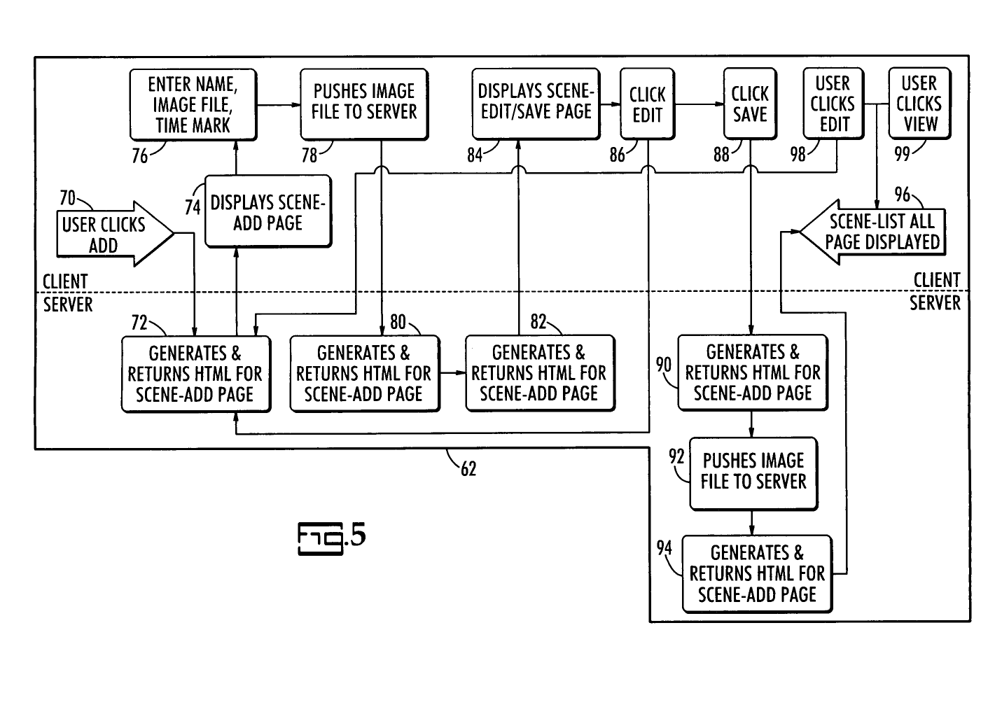

The preferred method of commerce for the present invention is generally illustrated in FIG. 3. In FIG. 3, a contractual arrangement is established at 40 wherein the product sponsor, the creator of the video scene and the creator of the publication determine the compensation parameters associated with the advertising relationship. For the purposes of the present invention the details of the parameters are not limited and the product sponsor, the creator of the video scene and the creator of the publication may be the same entity, separate entities or a combination thereof. At 42, a video is prepared wherein at least one scene of the video includes an image of the advertised item. The frame having the advertised item is captured at 44. The frame is annotated at 46 with any additional information which may be of interest to the viewer such as a correlation to the video broadcast. The annotated frame is published as print media or on the internet at 48. In a parallel process the video is broadcast at 50. In a particularly preferred embodiment the broadcast occurs after the annotated frame is published thereby allowing the broadcast information to be included with the publication. After the publication and viewing is complete the method ends at 52.

It would be apparent that the entire frame, or a portion of the frame, may be used. For example, the video frame may be cropped to better fit the publication format or a portion of the frame may be used such as only the item being advertised preferably with a sufficient amount of the scene to provide a context. The frame may also be a representative frame of the show which may, or may not, actually appear in a broadcast but which clearly represents the broadcast.

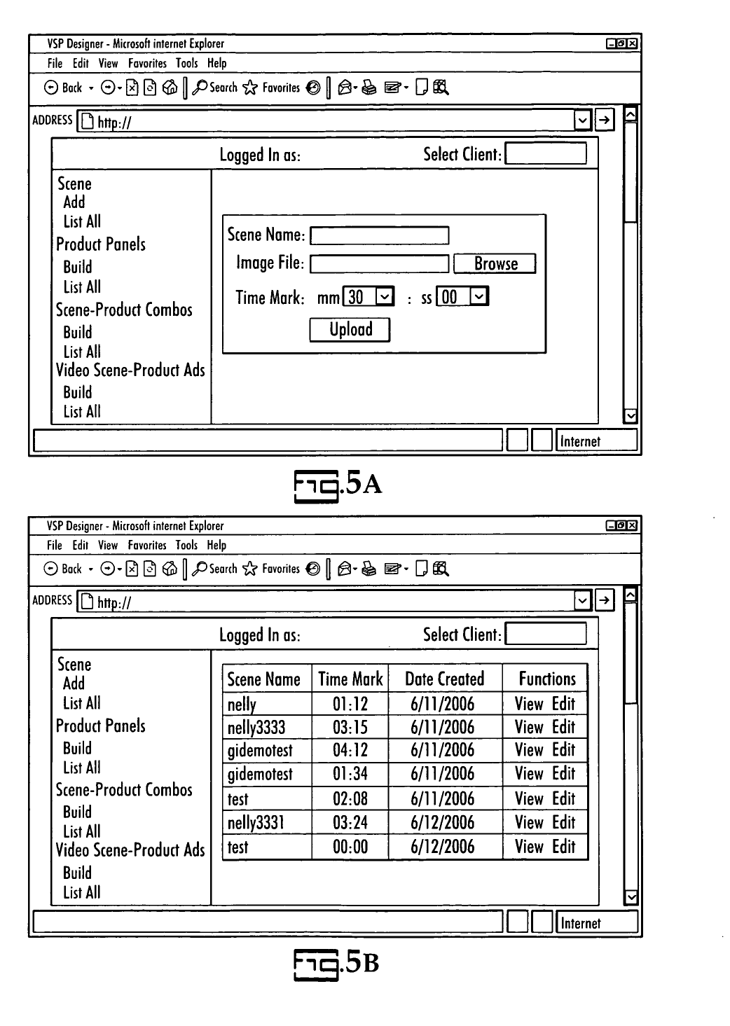

More particularly, the method for building the annotated video frames is illustrated in FIGS. 4-4A. As shown if FIG. 4, the overall process involves the following four components: a scene component at 62, a product panel component at 64, a scene-product combination component at 66, and a video-scene-product ad component at 68. These components provide the basic tools for constructing an annotated video frame. Using a standard client-server system, the client, which can range from television broadcasting companies to music video production companies, employs a login at 60 so as to gain access to the basic components of the process. An example of a default page or screen including the components of the present invention is illustrated in FIG. 4A. Accordingly, the client can send multiple requests to the server in an effort to construct an annotated video frame that can ultimately be published and connected to an e-commerce platform. Furthermore, these annotated video frames can be employed with print media or with video broadcasts through the internet. In the case of the print media, the present invention contemplates the ability of viewing a magazine or periodical on the internet in such a way that the pages of such a magazine can be flipped on line to locate a product of interest. Interactive icons, 62a, 64a, 66a, 68a, are provided for accessing each component. Interactive icon 62a, for example, allows the user to interact with a scene component, which will be more fully described herein.

FIGS. 5-8B illustrate the process details of the basic components of the present invention. Regarding the scene component, 62, the process includes the following steps. As used herein, “scene” refers to a still shot, also referred to as video frame, from a video including product placements. Once the client has logged in at 60, the client will make a request to the server to add a scene at 70. The server receives the scene-add request and thereafter generates and returns an HTML (Hyper Text Markup Language) for a scene-add page at 72. Upon receiving the HTML for the scene-add page, the client next displays the scene-add page at 74, and then enters a profile for the scene at 76, including entering the scene display name, the scene still shot image file, and a description such as a file name, on the client's local drive that is eventually uploaded to the server, and the time mark, which includes the time in minutes and seconds in the video from which the still shot is taken. An example screen shot illustrating this portion of the process is shown at FIG. 5A. Thereafter, the client sends the image file to server at 78. Upon receiving the image file, the server saves the image to a temporary directory at 80 and then generates and returns an HTML for scene-editing and/or for saving the page at 82. The client receives the scene-edit/save page HTML and displays this page at 84. The client can then edit the scene at 86, in which case the server would receive the edited scene at 72 and again generate and return a new HTML for a scene-add page. Alternative, client can instead chose to save the scene at 88, in which case the server would receive the request to save and thereafter move the scene image file from the temporary directory to a live directory and save the scene data in a database at 90. Upon saving the scene, the server redirects the scene to a scene-list all page at 92 and next generates and returns a scene-list all page HTML to client at 94. Client receives this HTML and can view any and all of the saved scenes on the scene-list all page at 96. The client can then either choose to view a particular scene at 99 or instead to edit a particular scene at 98. FIG. 5B illustrates an example screen shot for this portion of the process, where hypothetical screen names, time marks and interactive icons for view and edit are illustrated.

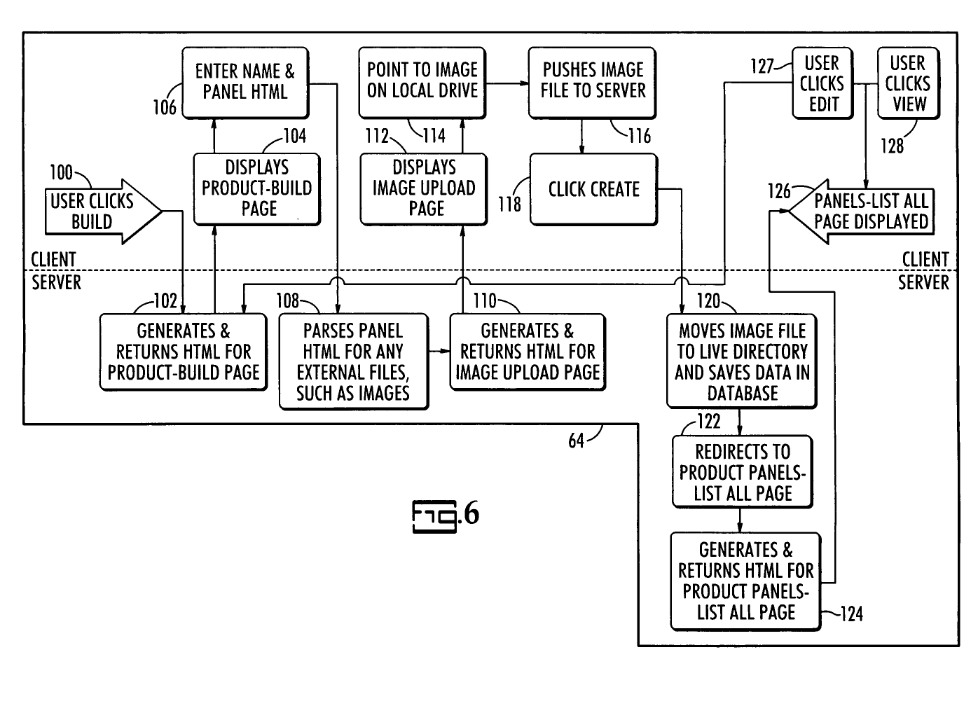

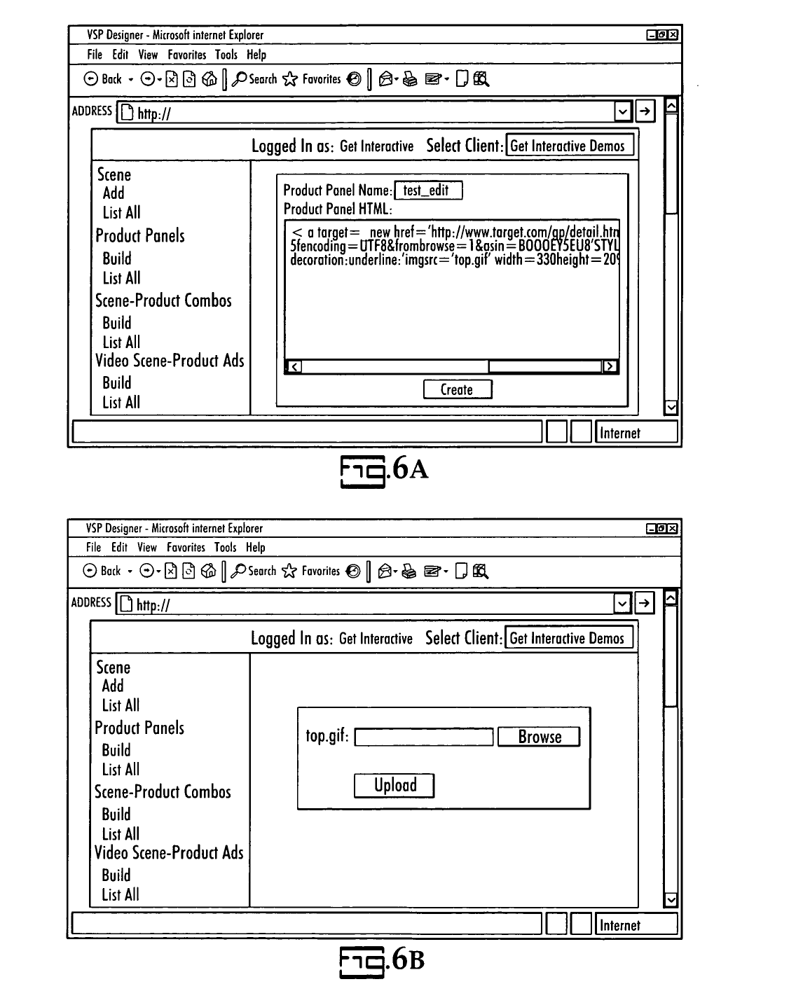

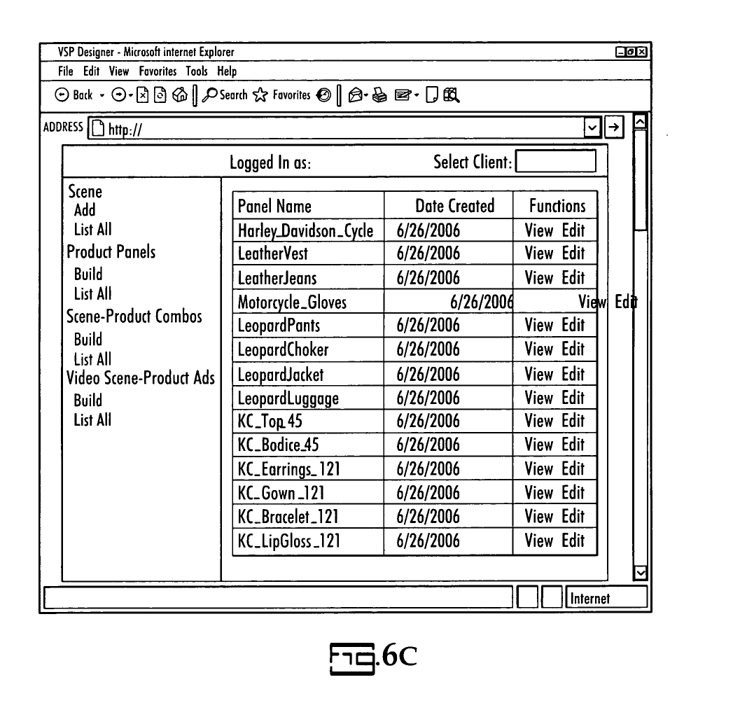

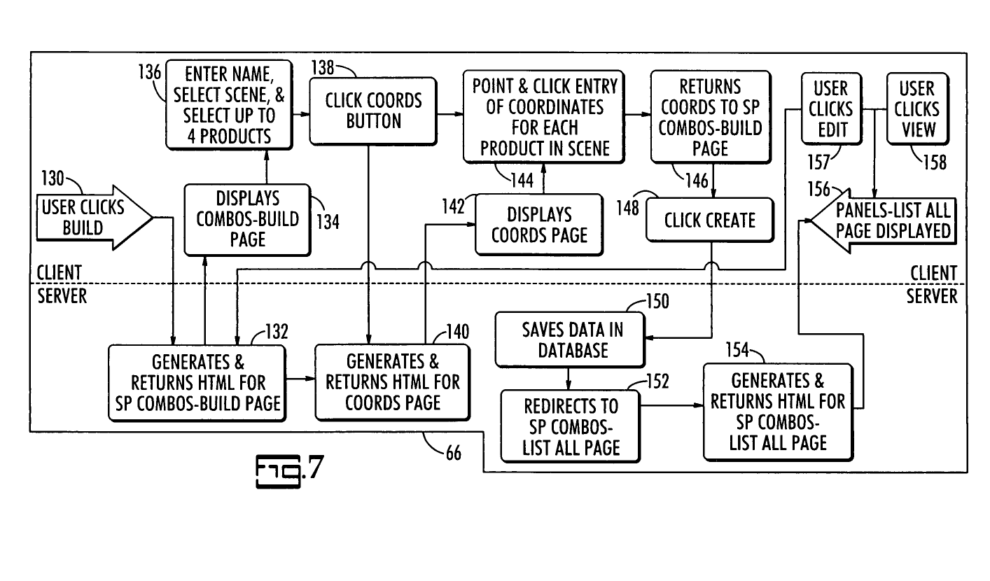

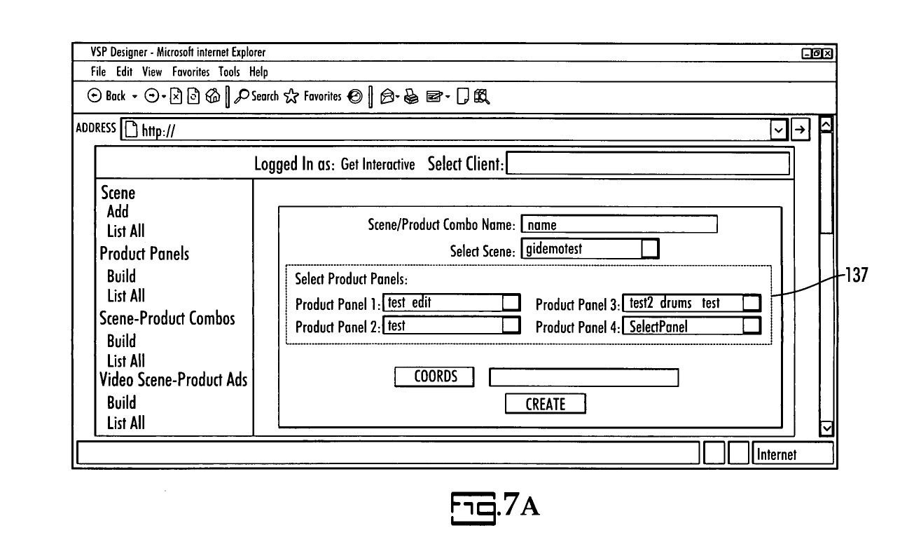

The product panel component, 64, is described in detail with reference to FIG. 6. As illustrated, the client initiates the process by making a request to server to build a product panel at 100 that will contain relevant information for the product. Upon receiving this request, the server then generates and returns an HTML for a product-build page at 102. The client can then display and view the product-build page at 104. The client can then enter a name for the product panel, and also enter an HTML for the panel that includes the panel information at 106. FIG. 6A illustrates an example of a screen shot showing this portion of the process. The panel HTML can include any number of features, such as text, color, images, etc., and these features can be generated from internal or external files to the client. Once the panel HTML is completed, the client sends it to the server, which parses out the panel HTML for any external files, such as images at 108. The server then generates and returns an HTML for an image upload page at 110. The client can then display an image upload page at 112 and access the image on client's local drive at 114. An example screen shot that can be generated from this portion of the process is shown in FIG. 6B. The client then sends the product panel image file to the server at 116 and requests server to create a panel at 118. The server, upon receiving this request, then moves the image file to a live directory and saves the product panel image data in the database at 120. The server can thereafter redirect the image file to the product panels-list all page at 122 and then generate and return an HTML for the product panels-list all page at 124. The client can thereafter display the panels-list all page at 126. The client can choose to either view a product panel from this list at 128 or instead choose to edit one or more of the product panels at 127. This portion of the process is shown by way of an example screen shot in FIG. 6C, where hypothetical panel names, date created and function fields are illustrated.

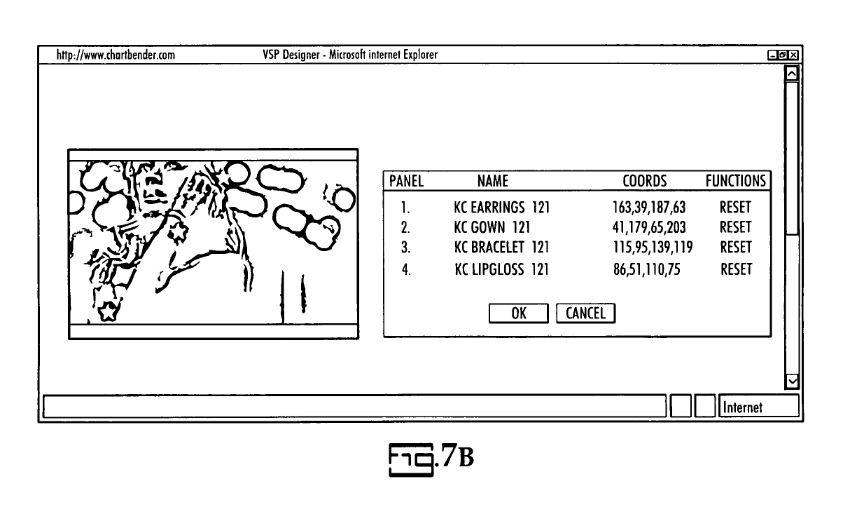

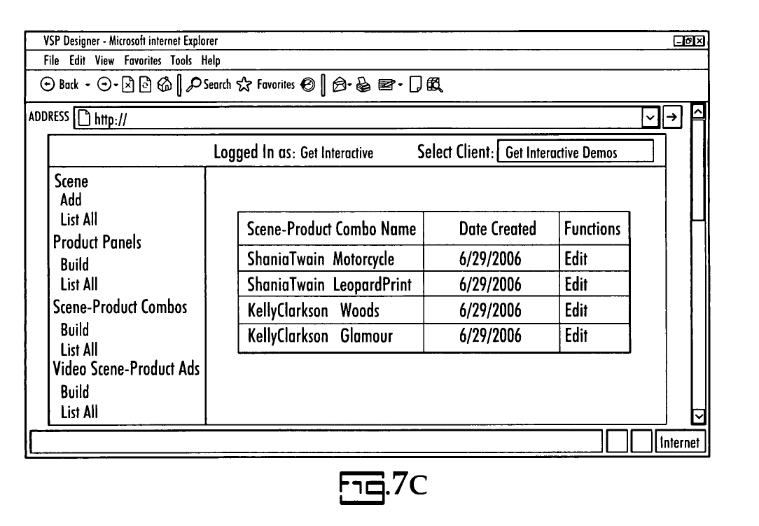

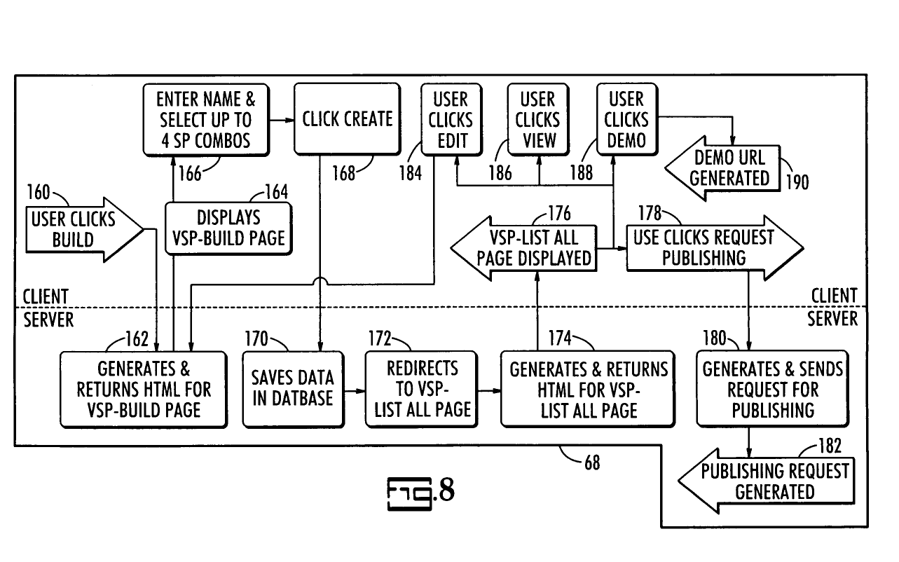

FIG. 7 illustrates the details of the scene-product combination component, 66. This component allows the product panels of choice to be attached or connected to the scenes of choice. To initiate the process, the client makes a request to build a scene-product combination at 130. In response, the server generates and returns an HTML for scene-product combination build page at 132. Client can then display the scene-product combination-build page at 134. This page can include a list of any saved scenes, a list of any saved product panels, and interactive icons for coordinates and for creating a scene-product combination. Client can therefore select a scene, select a product, or more than one product, to combine with the scene, and enter a name for the scene-product combination at 136. For example, and as shown in FIG. 7A, a client can choose four product panels, 137, to be combined with a particular scene. The client can then engage the coordinates icon at 138. The coordinates icon can be used to set or establish the screen coordinates a user can activate, such as by way of a “mouse-over” for the display of the product information to appear. Upon receiving the request to activate the coordinates icon, the server generates and returns an HTML for a coordinates page at 140. The client can then display the coordinates page at 142. This page displays the scene image and the product panels that were previously selected at 136. An illustrative screen shot of this portion of the process is shown at FIG. 7B. A hypothetical screen could include the selected screen image, a listing of the product panels and their names, an interactive icon to lock or unlock the panel, a listing of the coordinates, and an interactive icon to reset the coordinates. Although any means can be employed to set the coordinates of the product placements, a user can simply “unlock” or click, by mouse, the panel of choice, and then click on the image to place a product placement icon or marker that will set the coordinates for that product panel at 144. For example, letters, numbers or symbols, can be used as a product placement icons. Such an icon designates where the “mouse-over” will activate the product display on the web engine. Once the coordinates are set, the client can return them to the scene-product combination-build page at 146 and then request that the scene-product combination be created at 148. The server, having been requested to create the combination, then saves the scene-product data in the database at 150 and redirects the data to the scene-product combination-list all page at 152. The server next generates and returns an HTML for the scene-product combination-list all page at 154, at which time client can display the page at 156. The client can then choose to edit one or more scene-product combinations at 157. An example screen illustrating this portion of the process is shown at FIG. 7C, where hypothetical scene-product combo name, date created and an interactive icon for editing are illustrated.

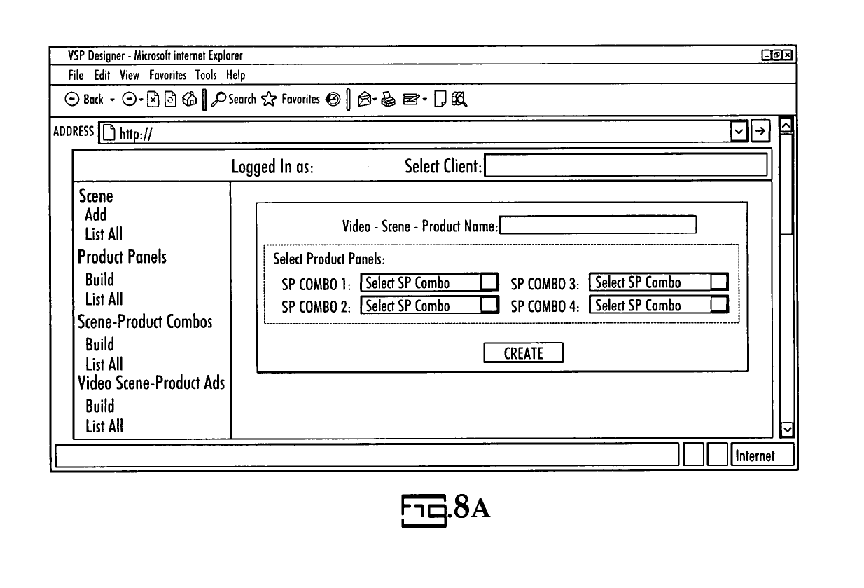

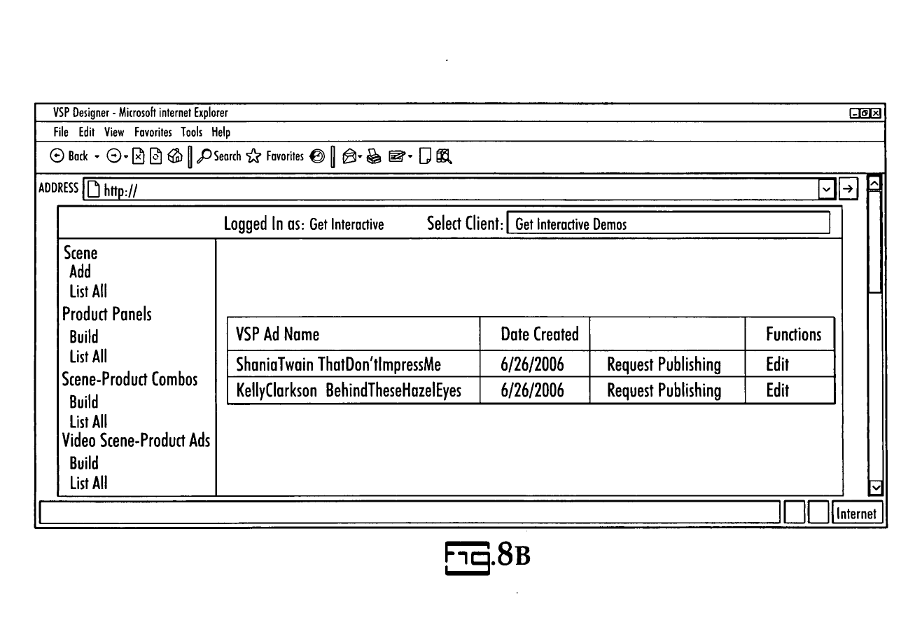

The fourth component, the video-scene-product ad component at 68, will be described in detail with reference to FIG. 8. As illustrated, the client initiates the process by requesting the server to build a video-scene-product advertisement at 160. The server generates and returns an HTML for the video-scene-product advertisement build page at 162. Client can then display this page at 164 and thereafter enter a profile, such as a name, for the video-scene-product advertisement, and select one or more scene-product combinations at 166. Next, the client makes a request that the server create a video-scene-product ad at 168. The server saves the data including the selected scene-product combinations in the database at 170 and thereafter redirecting the video-scene-product data to the video-scene-product list all page at 172. This portion of the process is illustrated in the example screen shot shown in FIG. 8A. As shown, a hypothetical screen can include a list of all scene-product combinations built and an interactive icon to create a video-scene-product advertisement. The server then generates and returns an HTML for the video-scene-product-list all page at 174. The client can then display the page at 176 and request that a particular video-scene-product ad be published at 178. In response to this request the server generates and sends a request for publishing to a publisher, such as a hierarchical index or a search engine, at 180 and a publishing request is generated at 182. Optionally, client can also choose simply to view the video-scene product ad at 186, to edit the ad at 184, or to request a demonstration at 188. In response to the request for demo, the server generates and provides the URL (Uniform Resource Locator) for a demonstration at 190. FIG. 8B shows an example screen shot of this portion of the process, where hypothetical video-scene-product name, date created, and interactive icons for requesting publication, demonstration, editing and viewing are illustrated.

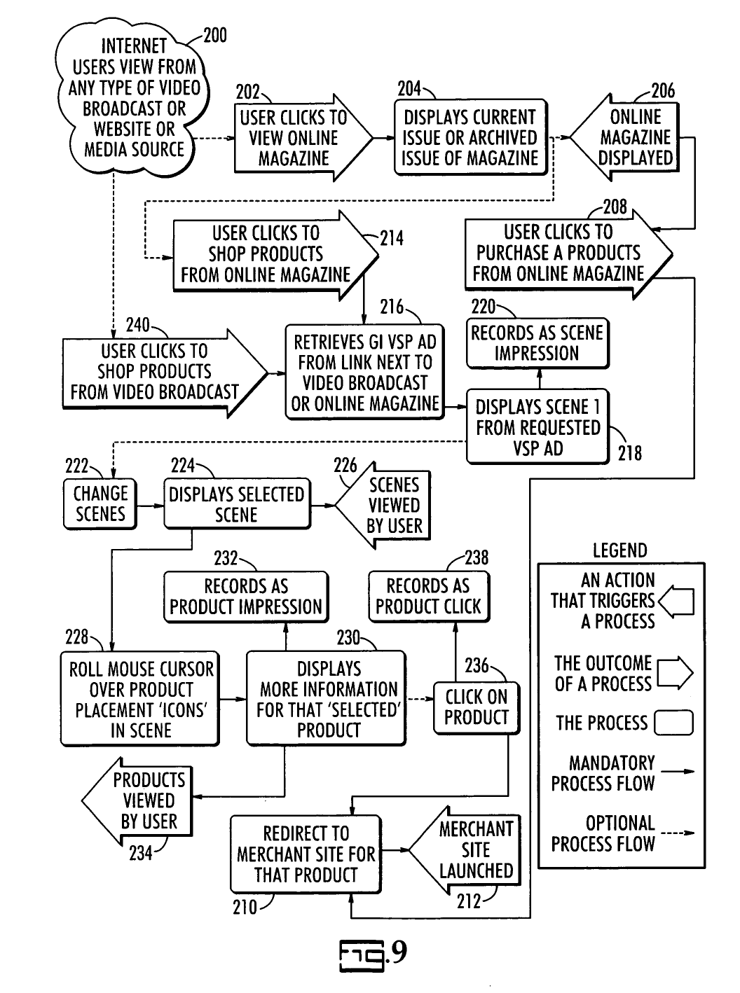

FIG. 9 provides a representation of how the overall process of the present invention can be employed on an interactive platform. As shown, users can view any type of video broadcast from the internet at 200. In one example, a user requests to view an on-line magazine at 202. Depending on which magazine is chosen from an on-line database, a current issue or archived issue of the magazine is retrieved at 204 and then displayed at 206. Once the magazine has been displayed, the user can select to purchase a product from the on-line magazine at 208. This command will redirect the user to the merchant site for that product at 210 and will launch the merchant web site at 212. Alternatively, the user can select to shop products from the on-line magazine at 214. This selection will prompt the retrieval of the video-scene-product advertisement created by the present process at 216. Next, the first scene selected by user is displayed at 218 at recorded as an impression at 220. The user can then optionally change the selected scenes at 222 and these changes are displayed at 224. Once the scenes of choice have been selected and then recorded as scene impressions, the scenes can be viewed by the user at 226. If the user requires or would like additional information about the products displayed in the scene, the user can, either when the first scene or subsequent scenes are displayed, use a mouse to roll a cursor over the product placement icons or markers in the scenes at 228. This will prompt the displaying of more information for the selected product at 230, which is then recorded as a product impression at 232. Accordingly, the user can then view the products at 234, or select a product at 236, which is then recorded as a product click or selection at 238. The user is directed to the merchant web site for that product at 210 and then the merchant web site is launched at 212.

In a second example, also shown in FIG. 9, the user can request to shop products directly from a video broadcast or from any website or media source, such as digital media, at 240. This selection will prompt the retrieval of the video-scene-product advertisement created by the present process at 216. Next, the first scene selected by user is displayed at 218 at recorded as an impression at 220. The user can then optionally change the selected scenes at 222 and these changes are displayed at 224. Once the scenes of choice have been selected and then recorded as scene impressions, the scenes can be viewed by the user at 226. If the user requires or would like additional information about the products displayed in the scene, the user can, either when the first scene or subsequent scenes are displayed, use a mouse to roll a cursor over the product placement icons or markers in the scenes at 228. This will prompt the displaying of more information for the selected product at 230, which is then recorded as a product impression at 232. Accordingly, the user can then view the products at 234, or select a product at 236, which is then recorded as a product click or selection at 238. At this point, the user is directed to the merchant web site for that product at 210 and then the merchant web site is launched at 212.

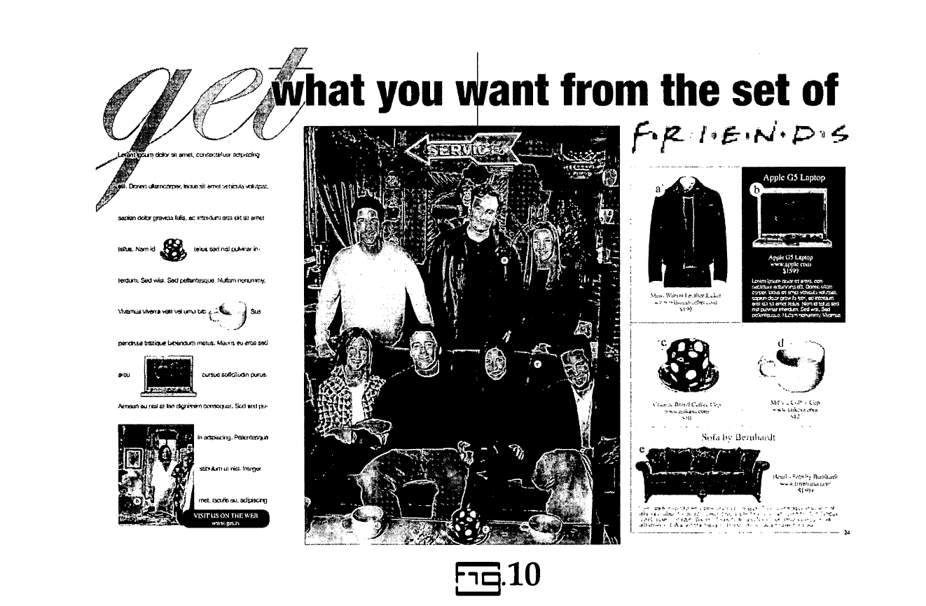

FIG. 10 is a representative print version of the publication. In the publication, certain items of potential interest have annotation both in the form of an indicia on the frame and in the form of a reproductive view of the item from the frame.

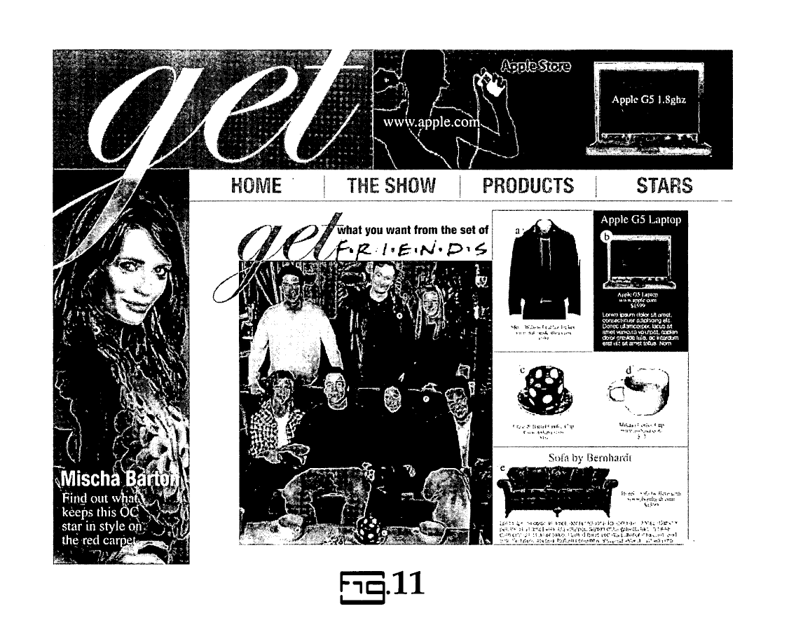

FIG. 11 is a representative internet web site view of the publication. As in the print version items of potential interest are annotated in the form of indicia on the frame and in the form of a reproduced or representative view of the item from the frame. The image may itself be an icon thereby allowing the user to click on the item to be directed to further information from the web site.

For the purposes of the present invention the broadcast includes all methods of displaying video images on a screen. The broadcast can be transmitted in real time such as in a television broadcast or it may be transmitted for viewing at select times at the discretion of the operator or viewer. The broadcast can be transmitted through terrestrial, cable, twisted copper or optical transmission methods or the image can be provided on analog or digital media. The broadcast includes those broadcast which are available to the public through publicly available transmission methods, free or otherwise, or it may include broadcast which have limited availability such as movie theaters and the like.

For the purposes of the present invention the screen is a surface upon which a broadcast is projected or otherwise visible. Included are phosphor based screens, plasma based screens and front or rear projection screens.

For the purposes of the present invention a computer terminal is a collection of input devices and output devices wherein the input devices send a command to a network, preferably the world wide web, and the output device receives and displays images and information responsive to the command.

For the purposes of the present invention a website is a set of stored information retrievable over a network by a computer terminal.

For the purposes of the present invention icons are images on a computer terminal which can be visualized and/or addressed by a computer terminal to direct the user to a specific stored image on a website.

Frame capture techniques are not limited herein and any technique used to capture a frame from an analog or digital video to transfer that frame to a fixed image is suitable for use herein whether that technique is analog or digital.

The present invention has been described with particular reference to the preferred embodiments. One of skill in the art would realize additional embodiments without departing from the metes and bounds of the present invention as more specifically set forth in the claims appended hereto.

1. A method for making scenes for use in advertisement, comprising:
providing a scene component wherein said scene component identifies a frame of a video wherein said frame comprises at least one product;
providing a product panel component wherein said product panel component annotates said frame with at least one product panel containing at least one attribute of said at least one product;
providing a scene-product component wherein said scene-product component defines a region by coordinates for said at least one product within said scene wherein a pointer is within said region attributes of said product are addressable; and
providing a video-scene-product advertising component wherein said video-scene-product advertising component displays said scene comprising said product, said product attributes.

2. The method as recited in claim 1, wherein said scene component comprises:
receiving a request by a client to add said scene;
receiving an HTML by said client for a scene-add page;
receiving a profile from said client for said scene-add page, said scene profile including a scene display name, a scene image file, a description for said scene image file, and a time mark;
receiving said scene image file from said client and saving said scene image file to a temporary directory;
receiving an HTML from said client for a scene-edit or save page;
if said scene image file is in final form, requesting by said client that said scene image file be saved;
if said scene image file is in need of editing, requesting by said client that said scene image file be edited; and
receiving by said client an HTML for a scene-list all page.

3. The method as recited in claim 2, wherein said scene-list all page includes said screen name, said time mark, an interactive icon for viewing said scene, and an interactive icon for editing said scene.

4. The method as recited in claim 1, wherein said product panel component comprises:
receiving a request from a client to build said product panel;
receiving an HTML from said client for a product-build page;
receiving a profile from by said client for said product panel, said product panel profile including a product panel name and an HTML for information relating to said product panel;
receiving an HTML from said client for a product panel image page;
receiving from said client a request to create said product panel based on said product panel image;
receiving an HTML by said client for a product panel-list all page and
if said scene image file is in need of editing, requesting by said client that said product panel be edited.

5. The method as recited in claim 4, wherein said product panel-list all page includes said product panel name, an interactive icon for viewing said product panel, and an interactive icon for editing said product panel.

6. The method as recited in claim 1, wherein said scene-product combination component comprises:
receiving a request from a client to build said scene-product combination;
receiving a request from said client for a scene-product combination build page, said scene-product combination build page including a scene list of said scene and any additional scenes added, a product panel list of said product panel and any additional product panels built, and an interactive icon for setting the coordinates of a product placement icon, said product panel placement icon being an interactive icon that, once engaged, displays a product panel from said product panel list;
receiving a profile from said scene-product combination, said scene-product combination profile including a scene-product combination name;
receiving by said client a scene from said scene list;
selecting by said client a product panel from said product panel list;
requesting by said client to set coordinates for said product panel;
receiving by said client an HTML for a coordinates page;
setting by said client said coordinates with said product placement icon;
requesting by said client the creation of said scene-product combination;
receiving by said client an HTML for a scene-product combination-list all page;
if said scene-product combination is in need of editing, requesting by said client that said scene-product combination be edited.

7. The method as recited in claim 6, wherein said scene-product combination-list all page includes said scene-product combination name and an interactive icon for editing said scene-product combination.

8. The method as recited in claim 1, wherein said video-scene-product advertisement component comprises:
requesting by a client to build said video-scene-product advertisement;
receiving by said client an HTML for a video-scene-product advertisement build page, wherein said video-scene-product advertisement build page includes a scene- product combination list of said scene-product combination and any additional scene-product combinations built;
entering by said client a profile for said video-scene-product advertisement, said video-scene-product advertisement profile including a video-scene-product advertisement name;
selecting by said client a scene-product combination from said scene-product combination list;
requesting by said client the creation of said video-scene-product advertisement;
receiving by said client an HTML for a video-scene-product advertisement-list all page;
if said video-scene-product advertisement is ready for publication, requesting by said client that said video-scene-product advertisement be published;
if said video-scene-product advertisement is in need of editing, requesting by said client that said video-scene-product advertisement be edited;
if said video-scene-product advertisement is ready for demonstration, requesting by said client that said video-scene-product advertisement be demonstrated.

9. The method as recited in claim 8, wherein said video-scene product advertisement-list all page includes said video-scene-product advertisement name, an interactive icon for requesting publication of said video-scene-product advertisement, an interactive icon for demonstrating said video-scene-product advertisement, an interactive icon for editing said video-scene-product advertisement, and an interactive icon for viewing said video-scene-product advertisement.

10. A method for making scenes for use in advertisement, comprising:
receiving a request from a client indicating a frame of a video comprising a product;
extracting said frame from said video;
annotating said frame with at least one product panel containing at least one attribute of said product;
defining a region by coordinates for said at least one product within said scene wherein when a pointer is within said region attributes of said product are addressable; and
providing a video-scene-product advertising component wherein said video-scene-product advertising component displays said scene comprising said product, said product pane and said addressable product attributes.

11. The method as recited in claim 10, wherein said scene component comprises:
receiving by said server a request to add said scene;
generating by said server and HTML for a scene-add page;
receiving by said server a profile for said scene-add page, said scene profile including a scene display name, a scene image file, a description for said scene image file, and a time mark;
saving by said server said scene image file to a temporary directory;
generating by said server an HTML for a scene-edit or save page;
if said scene image file is in final form, receiving by said server a request to save said scene image file, and saving by said server said scene image file;
if said scene image file is in need of editing, receiving by said server a request to edit said scene image file, and effecting by said server said editing; and
generating by said server an HTML for a scene-list all page.

12. The method as recited in claim 10, wherein said product panel component comprises:
receiving by said server a request to build said product panel;
generating by said server an HTML for a product-build page;
receiving by said server a profile for said product panel, said product panel profile including a product panel name and an HTML for information relating to said product panel;
generating by said server an HTML for a product panel image page;
receiving by said server a request to create said product panel based on said product panel image;
generating by said server an HTML for a product panel-list al page; and request that said product panel be edited, and effecting by said server said editing.

13. The method as recited in claim 10, wherein said scene-product combination component comprises:
receiving by said server a request to build a scene-product combination;
generating by said server an HTML for a scene-product combination build page, said scene-product combination build page including a scene list of said scene and any additional scenes added, a product panel list of said product panel and any additional product panels built, and an interactive icon for setting the coordinates of a product placement icon, said product panel placement icon being an interactive icon that, once engaged, displays a product panel from said product panel list;
receiving by said server a profile for said scene-product combination, said scene-product combination profile including a scene-product combination name, a scene selection from said scene list, and a product panel selection from said product panel list;
receiving by said server a request to set coordinates for said product panel;
generating by said server a request to set coordinates for said product panel;
generating by said server an HTML for a coordinates page;
receiving by said server a request to create said scene-product combination based on set coordinates;
generating by said server an HTML for a scene-product combination-list all page;
if said scene-product combination is in need of editing , receiving by said server a request that said scene-product combination be edited, and effecting by said server said editing.

14. The method as recited in claim 10, wherein said video-scene-product advertisement component comprises:
receiving by said server a request to build said video-scene-product advertisement;
generating by said server an HTML for a video-scene-product advertisement build page, wherein said video-scene-product advertisement build page includes a scene-product combination list of said scene-product combination and any additional scene-product combinations built;
receiving by said server a request to create said video-scene-product advertisement based on a video-scene-product advertisement profile, said video-scene-product advertisement profile including a video-scene-product advertisement name and a selected scene-product combination form said scene-product combination list;
generating by said server an HTML for a video-scene-product advertisement-list all page;
if said video-scene-product advertisement is ready for publication, receiving by said server a request that said video-scene-product advertisement be published, and effecting by said server said publication;
if said video-scene-product advertisement is in need of editing, receiving by said server a request that said video-scene-product advertisement be edited, and affecting by said server said editing by said server said editing;
if said video-scene-product advertisement is ready for demonstration, receiving by said server a request that said video-scene-product advertisement be demonstrated, and effecting by said server said demonstration.

15. A method for making scenes for use in advertisement, comprising:
sending a request to a server indicating a frame of a video comprising a product wherein:
a scene component extracts said frame;
a product panel component annotates said frame with at least one product panel containing at least one attribute of said product;
a scene-product component defines a region by coordinates for said at least one product within said scene wherein when a pointer is within said region attributes of said product are addressable;
a video-scene-product advertising component displays said scene comprising said product, said product panel and said addressable product attributes; and
receiving said product panel with said addressable product attributes.

16. The method as recited in claim 15, wherein said scene component comprises:
sending by said client a request to said server to add said scene;
generating and returning to said client by said server an HTML for a scene-add page;
entering by said client a profile for said scene-add page, said scene profile including a scene display name, a scene image file, a description for said scene image file, and a time mark;
sending by said client said scene image file to said server;
generating and returning to said client by said server an HTML for a scene-edit or save page;
if said scene image file is in final form, sending by said client to said server a request that said scene image file be saved, wherein said server effects said saving;
if said scene image file is in need of editing, sending by said client to said server a request that said scene image file be edited, wherein said server effects said editing; and
generating and returning to said client by said server receiving an HTML for a scene-list all page.

17. The method as recited in claim 15, wherein said product panel component comprises:
sending by said client to said server a request to build said product panel;
generating and returning to said client by said server an HTML for a product-build page;
entering by said client a profile for said product panel, said product panel profile including a product panel name and an HTML for information relating to said product panel;
generating and returning to said client by said server an HTML for a product pane image page;
sending by said client to said server a request to create said product panel based on said product panel image;
generating and returning to said client by said server an HTML for a product panel-list all page; and
if said scene image file is in need of editing, sending by said client to said server a request that said product panel be edited, wherein said server effects said editing.

18. The method as recited in claim 15, wherein said scene-product combination component comprises:
sending by said client to said server a request to build said scene-product combination;
generating and returning to said client by said server an HTML for a scene-product combination build page, said scene-product combination build page including a scene list of said scene and any additional scenes added, a product panel list of said product panel and any additional product panels built, and an interactive icon for setting the coordinates of a product placement icon, said product panel placement icon being an interactive icon that, once engaged, displays a product panel from said product panel list;
entering by said client a profile for said scene-product combination, said scene-product combination profile including a scene-product combination name;
selecting by said client a scene from said product panel list;
sending by said client to said server a request to set coordinates for said product panel;
generating and returning to said client by said server an HTML for a coordinates page;
setting by said client said coordinates with said product placement icon;
sending by said client to said server a request to create said scene-product combination;
generating and returning to said client by said server an HTML for a scene-product combination-list all page;
if said scene-product combination is in need of editing, sending by said client to said server a request that said scene-product combination be edited, wherein said server effects said editing.

19. The method as recited in claim 15, wherein said video-scene-product advertisement component comprises:
sending by said client to said server a request to build said video-scene-product advertisement; generating and returning to said client by said server an HTML for a video-scene product advertisement build page, wherein said video-scene-product advertisement build page, wherein said video-scene-product advertisement build page includes a scene-product combination list of said scene-product combination and any additional scene-product combinations built;
entering by said client a profile for said video-scene-product advertisement, said video-scene product advertisement profile including a video-scene-product advertisement name;
selecting by said client a scene-product combination from said scene-product combination list;
sending by said client to said server a request to create said video-scene-product advertisement;
generating and returning to said client by said server an HTML for a video-scene-product advertisement-list all page;
if said video-scene-product advertisement is ready for publication, sending by said client to said server a request that said video-scene-product advertisement be published, wherein said server effects publication;
if said video-scene-product advertisement is in need of editing, sending by said client to said server a request that said video-scene-product advertisement be edited, wherein said server effects said editing;
if said video-scene-product advertisement is ready for demonstration, sending by said client to said server a request that said video-scene-product advertisement be demonstrated, wherein said server effects said demonstrating.
